(19) United States
(12) Patent Application Publication
(10) Pub. No.: US 2016/0052516 A1
(43) Pub. Date: Feb. 25, 2016

(54) METHOD AND APPARATUS FOR DETECTING A POOR DRIVING PATTERN WHILE TRACKING A LANE

(71) Applicant: HYUNDAI MOTOR COMPANY, Seoul (KR)

(72) Inventors: Jin Kwon KIM, Suwon-Si (KR); Sam Yong KIM, Hwaseong-Si (KR); Ho Choul JUNG, Suwon-Si (KR); Byoung Joon LEE, Suwon-Si (KR)

(73) Assignee: HYUNDAI MOTOR COMPANY

(21) Appl. No.: 14/553,629

(22) Filed: Nov. 25, 2014

(30) Foreign Application Priority Data
Aug. 19, 2014 (KR) 10-2014-0107910

(51) Int. Cl. B60W 30/12; B60Q 9/00

(52) U.S. Cl. CPC B60W 30/12; B60Q 9/00

(57) ABSTRACT

The present inventive concept relates to a method and apparatus for detecting quickly and consistently a poor driving pattern for the change status of a lateral position of a vehicle and effectively warning a poor driving situation by applying a lane departure warning system assisting a driver of a vehicle by recognizing and tracking a lane.

### CROSS-REFERENCE TO RELATED APPLICATION

This application is based on and claims benefit of priority from Korean Patent Application No. 10-2014-0107910, filed on Aug. 19, 2014 in the Korean Intellectual Property Office, the content of which is incorporated herein in its entirety by reference.

### TECHNICAL FIELD

The present inventive concept relates to a method and apparatus for detecting a poor driving pattern while tracking a lane.

### BACKGROUND

Various methods have been developed for detecting and warning a poor driving situation while recognizing and tracking a lane at the time of driving of a vehicle. In particular, in the case of a cruise function or other automatic driving, guiding a poor driving situation is provided to a driver. Even for non-automatic driving situation, there is a need for the technology for quickly consistently detecting and warning a lane departure situation in advance depending on a poor driving due to fatigue or carelessness.

### SUMMARY OF THE INVENTION

One or more aspects of the subject inventive concept relates to a method and apparatus for detecting and warning a poor driving situation due to fatigue or carelessness, and more particularly, a method and apparatus for detecting a poor driving pattern capable of effectively warning a poor driving situation by detecting a poor driving pattern. According to one or more aspects of the subject inventive concept, a method and apparatus for quickly detecting a poor driving pattern and for stably changing c status of a vehicle's lateral position are described. The subject inventive concept enables effectively warning a poor driving situation by applying a lane departure warning system to assist a drive of a vehicle by recognizing and tracking a lane.

According to an aspect of the present inventive concept, in order to achieve the above object, a method for detecting a poor driving pattern based on a measurement of a lateral position change of a vehicle comprises steps of: determining a direction change by tracking a progress of the lateral position change of the vehicle in a road from a vehicle driving information, calculating movement amount of a lateral distance from a previous direction change position to a current direction change position based on a difference of a lateral position change amount; and determining whether it is the poor driving by comparing the movement amount of the lateral distance with a reference value.

In the step of determining a direction change position, a position which the lateral position change is maintained in a predetermined range during a predetermined time may be determined as the direction change position.

In the step of determining a direction change position, corresponding data, which a change of a value greater than the width between the lanes based on a minimum value is detected, of a sorting array in ascending order or descending order of the absolute value of a lateral position change data during a predetermined time in a progress of the lateral position change, may be eliminated.

In the step of determining whether it is the poor driving, if the movement amount of the lateral distance is more than the reference value, it may be determined as the poor driving, and if the vehicle moves to a vicinity of a center of the road or the movement amount of the lateral distance is generated during a time longer than a setting time, it may be excluded from the poor driving.

In the step of determining whether it is the poor driving, the reference value may be variably applied depending on a width of the road or a number of surrounding vehicles.

The method for detecting a poor driving may further comprise the step of determining a poor driving level corresponding to a poor driving situation of a driver for the poor driving and controlling a corresponding warning output.

The poor driving level may be determined by reflecting a size of the movement amount of the lateral distance, an event generating frequency of the direction change, or whether to intrude a lane or not or its occurrence frequency.

An apparatus for detecting a poor driving according to another aspect of the present invention comprises: a direction change recognizer configured to determine a direction change position by tracking a progress of a lateral position change of the vehicle in a road from a vehicle driving information; a lateral change module configured to calculate movement amount of a lateral distance from a previous direction change position to a current direction change position based on a difference of a lateral position change amount; and a poor driving detector configured to determine whether it is the poor driving by comparing the movement amount of the lateral distance with a reference value.

The direction change recognizer may determine a position which the lateral position change is maintained in a predetermined range during a predetermined time as the direction change position.

The direction change recognizer may eliminate corresponding data, which a change of a value greater than the width between the lanes based on a minimum value is detected, of a sorting array in ascending order or descending order of the absolute value of a lateral position change data during a predetermined time in a progress of the lateral position change.

The poor driving detector may determine it as the poor driving if the movement amount of the lateral distance is more than the reference value, and exclude it form the poor driving if the vehicle moves to a vicinity of a center of the road or the movement amount of the lateral distance is generated during a time longer than a setting time.

The poor driving detector variably may apply the reference value depending on a width of the road or a number of surrounding vehicles.

The apparatus for detecting a poor driving may further comprise a fatigue/carelessness driving level module configured to determine a poor driving level corresponding to a poor driving situation of a driver for the poor driving and control a corresponding warning output.

The fatigue/carelessness driving level module may determine the poor driving level by reflecting a size of the movement amount of the lateral distance, an event generating frequency of the direction change, or whether to intrude a lane or not or its occurrence frequency.

A method and apparatus for detecting a poor driving pattern according to the present invention can quickly and consistently detect a poor driving pattern for the change status of a vehicle's lateral position and effectively warning a poor driving situation by determining the position, which the lateral movement amount does not become large anymore during a predetermined time, as a direction change position, and based on this, calculating the movement amount of the lateral distance.

Also, a poor driving pattern can be determined depending on the driving status such as the cases of movement in the vicinity of the center, the time length of a distance movement is large, etc., and in consideration of the width of a road, the detecting frequency of a surrounding vehicle, etc., it is possible to guide a poor driving situation according to the driver's fatigue or carelessness level.

### BRIEF DESCRIPTION OF THE DRAWINGS

The above and other aspects, features and advantages of the present inventive concept will be more apparent from the following detailed description taken in conjunction with the accompanying drawings, in which like reference characters may refer to the same or similar parts throughout the different views. The drawings are not necessarily to scale, emphasis instead being placed upon illustrating the principles of the embodiments of the present inventive concept. In the drawings, the thickness of layers and regions may be exaggerated for clarity:

FIG. 1 is a block diagram of an apparatus for detecting a poor driving according to an embodiment of the present inventive concept.

FIG. 2 is a flow chart for explaining the operation of an apparatus for detecting a poor driving according to an embodiment of the present inventive concept.

FIG. 3 is a diagram for explaining the concept of a direction change position according to some aspects of the present inventive concept.

FIG. 4 is a diagram for comparatively explaining a method for determining a direction change position according to some aspects of the present inventive concept and a conventional method for determining a direction change position.

FIG. 5 is a diagram for explaining the elimination of an unstable state of a lateral position change data according to some aspects of the present inventive concept.

FIG. 6 is a diagram for explaining the sorting array used for determining a lateral change position according to some aspects of the present inventive concept.

FIG. 7 is a diagram for explaining an example with large movement amount of a lateral distance, not related to a poor driving pattern according to some aspects of the present inventive concept.

### DETAILED DESCRIPTION OF THE PREFERRED EMBODIMENTS

Hereinafter, the present inventive concept will be described in detail with reference to the drawings. At this time, in each of the drawings, the same components are denoted by the same reference symbols, if possible. Further, detailed descriptions for the previously known features and/or configurations are omitted. In the description below, parts required to understand operations in accordance with various embodiments will be explained in priority, the descriptions for elements, which may obscure the gist of the descriptions, are omitted. It can also be shown schematically some of the elements in the figures are exaggerated or omitted. Not utterly reflect an actual size to the size of each element, so that they are not intended to limit the content that is specified here by the relative size and spacing of the elements drawn in the figure, respectively.

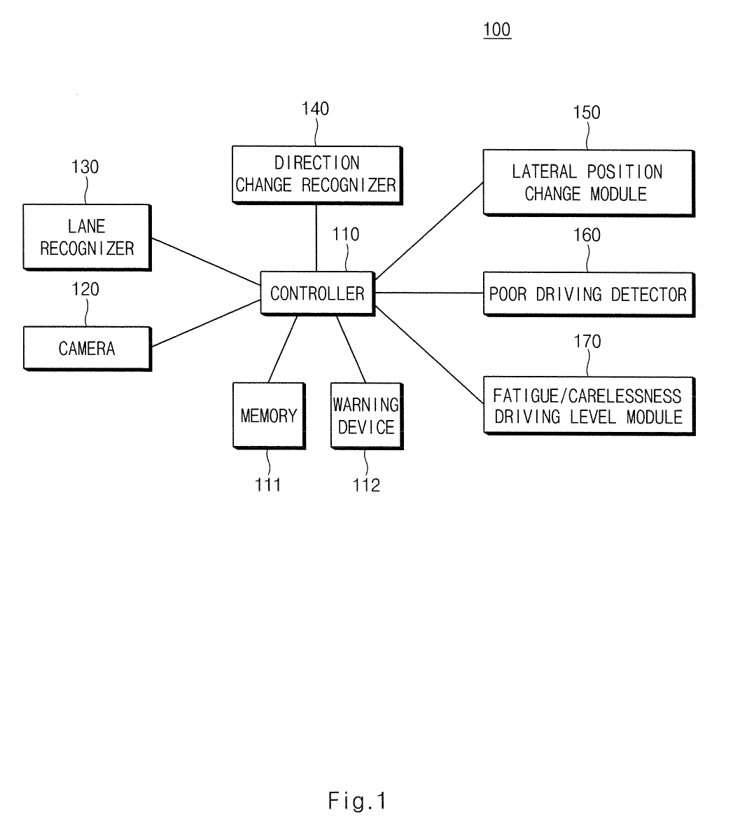

FIG. 1 is a block diagram of an apparatus for detecting a poor driving according to an embodiment of the present inventive concept.

FIG. 1 is a block diagram of an apparatus for detecting a poor driving according to an embodiment of the present inventive concept. Referring to FIG. 1, an apparatus 100 for detecting a poor driving (pattern) according to an embodiment of the present inventive concept may include a controller 110, a memory 111, a warning device 112, a camera 120, a lane recognizer 130, a direction change recognizer 140, a lateral position change calculator 150, a poor driving detector 160 and a fatigue/carelessness driving level module 170. Each part of the components of the apparatus 100 for detecting a poor driving can be implemented by combining software and hardware or a combination thereof. The apparatus 100 for detecting a poor driving according to an embodiment of the present inventive concept can be applied to various systems assisting a driver of a vehicle by recognizing and tracking a lane such as a Lane Detection Warning System, or other systems. The subject apparatus is configured to quickly and consistently detect a change status of a lateral position of a vehicle and effectively warn a poor driving situation.

First, the operation of each part of components of the apparatus 100 for detecting poor driving will be briefly explained.

The controller 110 may be a semiconductor processor responsible for overall control, and the controller 110 can be implemented to include the features of some or all of each part of the components.

The memory 111 may store and manage setting data for input to each part of the components or data generated in each part of the components, and store and manage an image of the camera 120, which can be properly installed inside or outside of the vehicle in order to take a front image.

The warning device 112 may include a speaker, display device, etc. for warning various poor driving situations such driving carelessness, etc. by audio and/or video displayed on a screen when detecting the poor driving pattern as described below. In some aspects, warning device 112 may interoperate with a navigation terminal or a mobile terminal of a driver or user. These separate electronic devices may be also be utilized as warning means.

The lane recognizer 130 may discriminate a lane from the image of the camera 120, determine whether the vehicle is properly running in the both sides of the lane or not, and determine the center or the vicinity of the center, etc. (for example, a predetermined width from the center to both sides) in both sides of the lane.

The direction change recognizer 140 determines the direction change position by tracking the progress of the lateral position change in the roadway for the vehicle from the vehicle driving information received from various sensors or a CAN (Controller Area Network) bus and/or the like. As described herein, the direction change recognizer 140 can determine the position that the lateral position change is maintained in a predetermined range during a predetermined time, as the direction change position. Also, the direction change recognizer 140 can determine the direction change position by eliminating the unstable data (e.g., with the change of the value greater than the width between the lanes based on a detected minimum value) of a sorting array (e.g., in ascending order or descending order) of the absolute values of the lateral position change data during a predetermined time throughout the lateral position change.

The lateral change module 150 calculates the movement amount of the lateral distance from the previous direction change position to the current direction change position recognized by the direction change recognizer 140 based on the difference in the lateral position change amount.

The poor driving detector 160 determines whether it is the poor driving or not by comparing the movement amount of the lateral distance with a reference value. If the movement amount of the lateral distance is more than the reference value, it is determined as the poor driving, and if the vehicle moves to the vicinity of the center of the roadway, or the movement amount of the lateral distance is obtained during a time period longer than a setting time, poor driving can be excluded. In addition, the poor driving detector 160 can variably apply the above reference value according to the width of the roadway or the detected value by a surrounding vehicle.

The fatigue/carelessness driving level module 170 can determine the poor driving level for the poor driving situation of the driver with respect to the poor driving as the above determined and control the corresponding warning output. At this time, the fatigue/carelessness level calculator 170 can determine the poor driving level by reflecting the size of the movement amount of the lateral distance, the event occurrence frequency of the direction change, or whether a lane is intruded or not and/or its occurrence frequency.

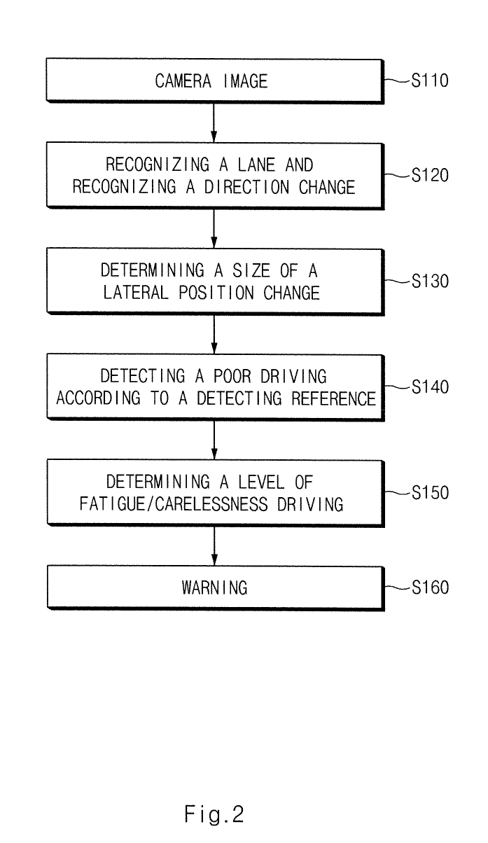

FIG. 2 is a flow chart for explaining the operation of an apparatus for detecting a poor driving according to an embodiment of the present inventive concept. With reference to a flow chart of FIG. 2, the operation of the apparatus 100 for detecting a poor driving according to an embodiment of the present inventive concept will be described in more detail.

First, the camera 120 which can be properly installed inside or the outside of the vehicle for taking a front image obtains an image (data) including the lane in front of the vehicle (S110).

The lane recognizer 130 may discriminate a lane using the image of the camera 120, determine whether the vehicle is properly running in between sides of the lane or not, determine the center or the vicinity of the center the lane (for example, by using a predetermined width from the center to both sides), and cause a warning indication to be outputted via a message or audio through the warning device 112 when the vehicle comes close to the lane within a predetermined threshold distance depending on the running state of the vehicle in both sides of the lane. In other words, the lane recognizer 130 can determine whether the vehicle is close to the lane or not (for example, the distance between the side of the vehicle and the lane) (S120). For example, the threshold distance between the side of the vehicle and the lane may be set in advance in consideration of the installation position of the camera 120 or the angle towards the road surface and the like.

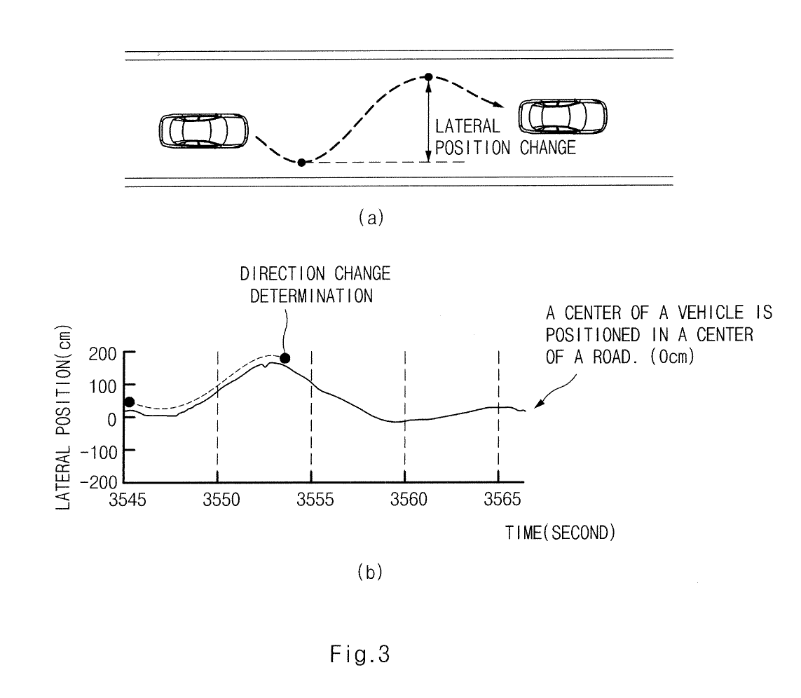

FIG. 3 is a diagram for explaining the concept of a direction change position according to some aspects of the present inventive concept. In some aspects, the lane recognizer 130 recognizes that the vehicle is running in the lane and assists the safe running of the driver, and at the same time, may give an in-advance notice or warning. The direction change recognizer 140 may determine whether there is a direction change position distinctly showing a lateral position change during driving in the roadway within both sides of the lane as shown in (a) of FIG. 3.

In some aspects, the apparatus 100 for detecting a poor driving can receive the vehicle driving information including the corresponding electrical signal (data) directly or through a CAN (Controller Area Network) according to the operation of a vehicle speed sensor, a yaw-rate sensor, a three-axis acceleration sensor, or a steering-angle sensor and the like. The direction change recognizer 140 can determine whether a direction change position distinctly showing and maintaining the lateral position change exists or not by analyzing the above vehicle driving information and tracking the change amount of the lateral position from the center of the road depending on the time as shown in (b) of FIG. 3. In particular, the direction change recognizer 140 can determine the position, in which the lateral movement amount does not increase anymore during a predetermined time, as the direction change position information. The direction change position information is stored in the memory 111.

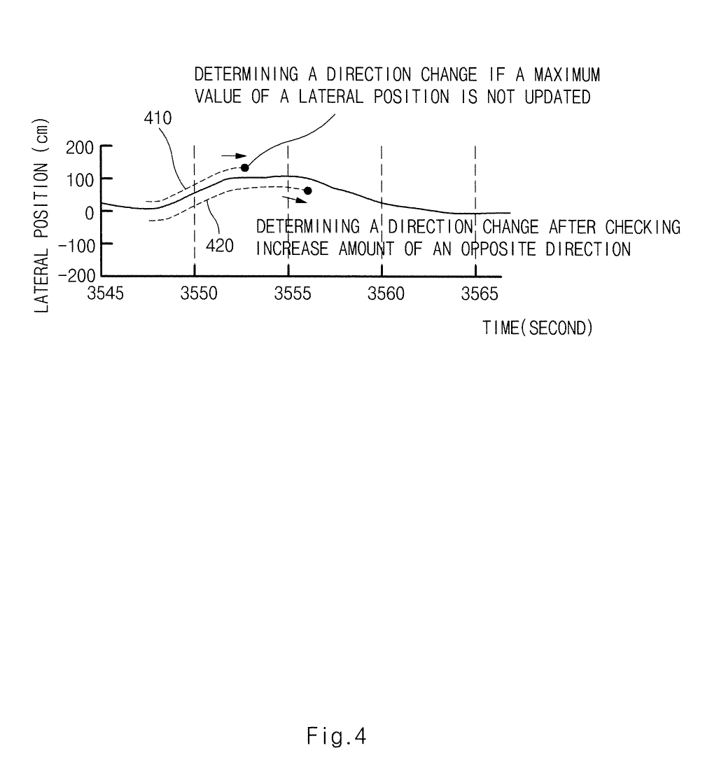

FIG. 4 is a diagram for comparatively explaining a method for determining a direction change position according to some aspects of the present inventive concept and a conventional method for determining a direction change position. In some implementations, the progress of the lateral position change is analyzed as shown in FIG. 4. As depicted in 410 of FIG. 4, the method of the present inventive concept for determining the direction change position checks that the lateral position change amount is sustained in either direction (e.g., left, or right) without the rising change more than a predetermined flow amount. This can prevent a delayed detection as experienced by the conventional methods which check whether the direction change position value is increased to the opposite direction. This proposed method can early detect the direction change position, as compared to the conventional method that only checks increment to the opposite direction after the change amount of the lateral position is maintained (or it does not increase anymore) without the rising change as shown in 420 of FIG. 4. In particular, when the vehicle does not immediately change the direction to the opposite direction at the position which movement amount is the maximum value as shown in FIG. 4 and is running below a predetermined flow rate (fluctuation) so that the lateral position change becomes small, the proposed method of the present inventive concept can detect the direction change position earlier as shown in 410. The detection may be delayed in the conventional method for determining the direction change position as shown in 420, and thus it can be seen that the determination time difference is remarkable.

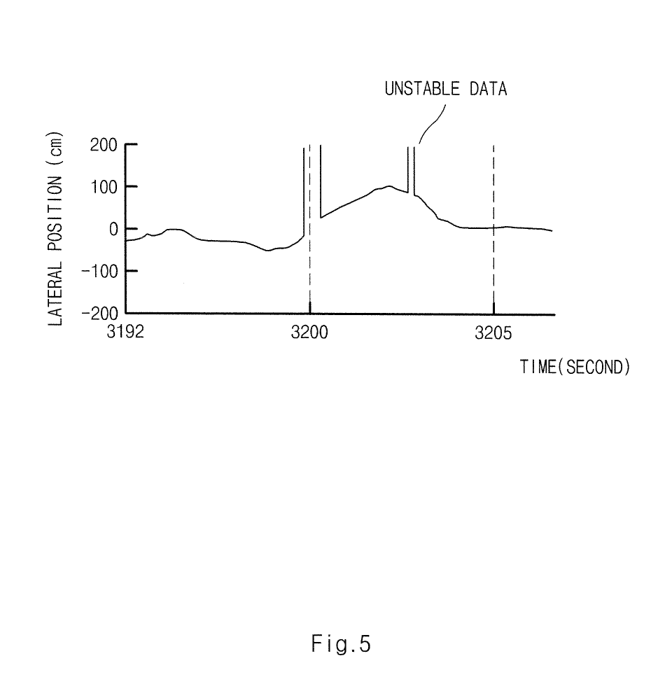

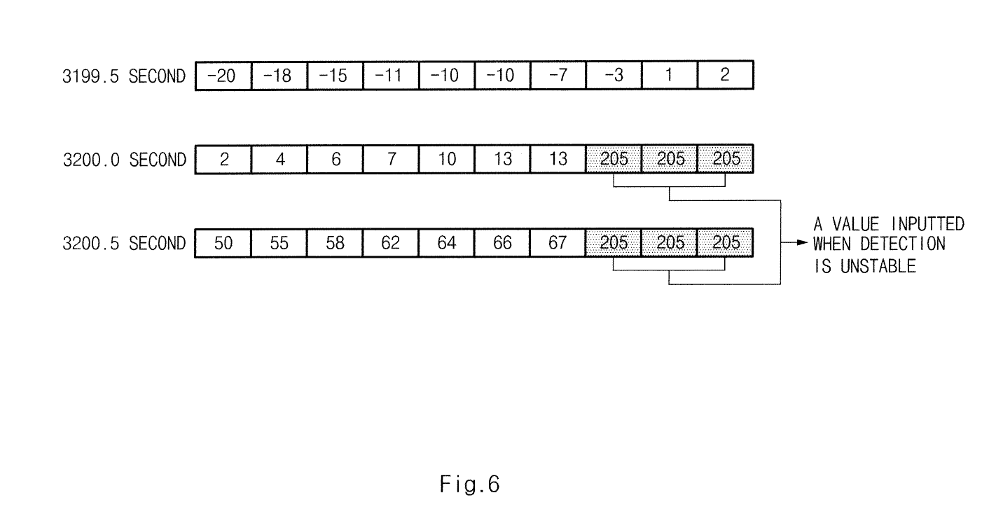

FIG. 5 is a diagram for explaining the elimination of an unstable state of a lateral position change data according to some aspects of the present inventive concept. Depending on how fast the system performance, the vehicle driving information, and other information is changed by disturbance or an error can be measured. The unstable data is an indication that the progress of the lateral position change is temporarily and rapidly changing as shown in FIG. 5. In some aspects of the present inventive concept, in the direction change position determination by the direction change recognizer 140, causes the unstable data detected during a short time to be eliminated from the utilization for determining the direction change position. The elimination can be performed by using a sorting array (e.g., in ascending order or descending order) of the absolute values of the lateral position change data (e.g., corresponding to the change amount of the lateral position) as shown in FIG. 6.

FIG. 6 is a diagram for explaining the sorting array used for determining a lateral change position according to some aspects of the present inventive concept. In some aspects, if the vehicle moves to the right side direction in the road, the lateral position value may be increased, and if it moves to the left side direction, it may be decreased. And as shown in FIG. 5, if suddenly a large value appears due to the instability of the detected data, while the vehicle is moving to the right side, it is difficult to determine the direction change based on the maximum value of the lateral position. Thus, if the direction change is determined by the sorting array, as shown in FIG. 6, on the basis of the minimum value, not the maximum value, it is not affected by the detection instability suddenly showing a large value during a short time. For example, in the sorting array data of the lateral position change data collected in each situation of 3199.5 seconds, 3200.0 seconds and 3200.5 seconds, the value of the lateral position that shows a change larger than the width between the lanes can be eliminated. In other words, an in the above example, the value of a short time detection instability is accumulated in the maximum value part of the sorting array data, and if the direction change is determined on the basis of the minimum value, it is not affected by the short detection instability. Thus, the direction change recognizer 140 determines the position at which the lateral distance movement amount does not increase anymore during a predetermined time, as a direction change position based on the progress of the lateral position change. By determining the direction change position throughout the lateral position change, the direction change recognizer 140 eliminates the lateral change data with changes larger than the width between the lane lines. The eliminated data is detected based on the minimum value in the sorting array of the absolute value of the lateral position change data in the collecting unit (for example, 0.5 seconds) of each lateral position change data. The error of the determination by the unstable data detected during a short time can be eliminated and it is possible to determine the accurate direction change position.

As described above, the lateral position change data have a positive value relative to the right side direction on the basis of the center of the road and a negative value relative to the left side direction on the basis of the center of the road. As a result, the above minimum value in the sorting array of the absolute value of the lateral position change data corresponds to the position at which the lateral position change data is to be minimum relative to the right side direction, and corresponds to the position at which the lateral position change data is to be maximum relative to the left side direction. That is, in the graph showing respective direction change position, data in the center of the road corresponds to the minimum value which is to be the above described basis.

In some implementations, the direction change recognizer 140 determines the position, at which the lateral movement amount does not increase anymore during a predetermined time. In this way, as a direction change position on the basis of the progress of the lateral position change, the lateral position calculator 150 can calculate the movement amount of the lateral distance from the previous direction change position to the current direction change position based on the difference of the lateral position change amount (S130).

The poor driving detector 160 can determine whether it is the poor driving pattern corresponding to the driving situation by comparing the movement amount of the lateral distance calculated by the lateral change module 150 with a reference value (S150). For example, if the movement amount of the lateral distance is more than the reference value, since it is likely to intrude a lane, at this time, it is determined as the poor driving pattern. The poor driving pattern may be recognized as the driving situation related to fatigue or carelessness of the driver and the like. As described herein, if the vehicle moves to the vicinity of the center of the road, it can be adaptively determined whether it is the poor driving pattern or not, by considering other driving condition such as the case, in which the time length of the lateral distance movement is large, and the like.

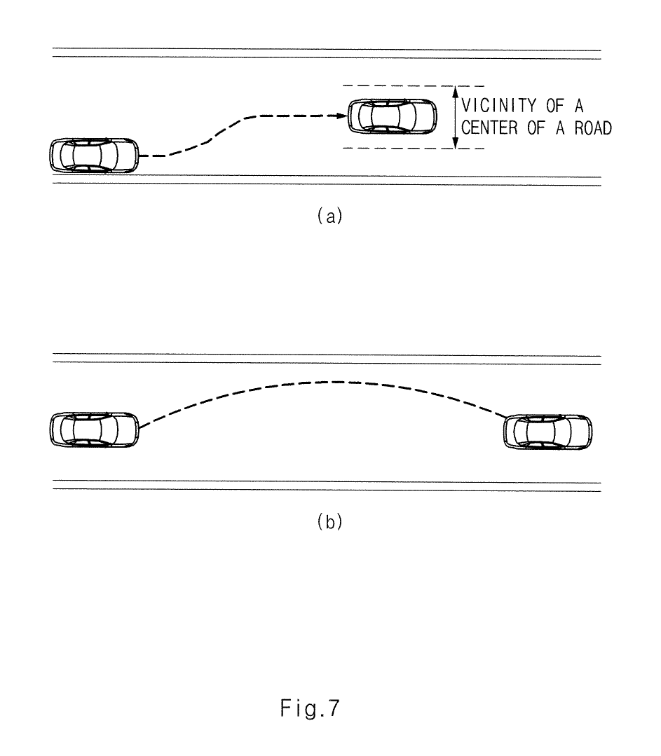

FIG. 7 is a diagram for explaining an example with large movement amount of a lateral distance, not related to a poor driving pattern according to some aspects of the present inventive concept. Even though the movement amount of the calculated lateral distance is more than the reference value, the lateral position change is generated in order to move the vehicle from the edge of the road to the center of the road as shown in (a) of FIG. 7. In this case, as the lane recognizer 130 recognizes the movement to the vicinity of the center based on the image of the camera 120, the fatigue/carelessness driving level module 170 does not determine the corresponding lateral position change or the movement amount of the lateral distance as the poor driving pattern regarding as the driving situation such as the fatigue/carelessness of the driver and the like.

Also, as shown in (b) of FIG. 7, even though the movement amount of the lateral distance from the previous direction change position to the current direction change position is more than the reference value, if the time length of the movement of the corresponding lateral distance is larger than a predetermined setting time, the poor driving detector 160 does not determine the corresponding lateral position change or the movement amount of the lateral distance as the poor driving pattern regarding as the driving situation such as the fatigue/carelessness of the driver and the like. Even though the lateral change is large, if it is slowly generated over a long time, it is because the driver is likely not to recognize the poor driving. For example, in the case of the driver who loosely drives, this driving situation can be occurred, and also, this driving situation can be commonly occurred depending on a driver in a long straight road.

With regard to the detecting reference value for comparing with the movement amount of the lateral distance, more accurate determination for a poor driving situation is possible by variably adjusting the driving situation reflecting the width of the road, detecting frequency of the surrounding vehicle by the poor driving detector 160. In some cases, through the user interface (for example, a terminal screen) provided by the poor driving detector 160, the reference value can be arbitrarily adjusted by the driver or the user depending on the situation of driving or running, the reference value can be arbitrarily adjusted by the driver or the user using a button provided in the poor driving detector 160.

For example, since a driver tends not to make an utmost effort to maintain the lateral position if the road is broad, if the width of the road detected from the image of the camera 120 is more than a predetermined value, the poor driving detector 160 can increase the predetermined value and apply as the detecting reference value, compared to otherwise.

Also, since a driver tends not to make an utmost effort to maintain the lateral position if the number of the surrounding vehicle is small, if the number of the surrounding vehicle is less than a predetermined value, the poor driving detector 160 can increase and apply the above detecting reference value, compared to otherwise. The poor driving detector 160 can calculate the number of the surrounding vehicles such as in the front, the rear, or the side, of the vehicle by using a radar sensor. The radar sensor can be installed on the vehicle besides the image of the camera 120. The radar sensor may be installed on at least one position in the front, the rear, and/or the side (right and left) of the vehicle and used.

As described above, the poor driving is determined by the poor driving detector 160. The fatigue/carelessness driving level module 170 can calculate the corresponding level for the poor driving situation such as the fatigue or carelessness of the driver (S150), and exert control to cause outputting a corresponding warning sound or message through the warning device 112 (S160). The fatigue/carelessness driving level module 170 can determine the poor driving level such as the fatigue or carelessness of the driver, etc. depending on the respective weight value by reflecting the size of the lateral position change (the movement amount of the lateral distance) of the vehicle, the occurrence frequency of the lateral position change event (the direction change event), or whether to intrude a lane or not or its occurrence frequency, and the warning device 112 can cause the warning sound or message different from each other depending on the corresponding poor driving level to be outputted.

If the degree of the fatigue or careless of the driver is large, since the possibility, which the lateral position change or the movement amount of the lateral distance calculated as the above described is to become large, will be increased, for example, if the movement amount of the lateral distance is large, the poor driving level such as the fatigue or careless of the driver, etc. can be increased. At this time, the movement amount of the lateral distance is pre-defined as a plurality of steps and the warning sound or message different from each other can be outputted step by step.

Also, if the degree of the fatigue or careless of the driver is large, since the generating frequency of the lateral position change event will be increased, for example, if the generating frequency of the direction change event is large, the poor driving level such as the fatigue or careless of the driver, etc. can be increased. At this time, the generating frequency of the direction change event (that is, a predetermined number of occurrences per unit time) is pre-defined as a plurality of steps and the warning sound or message different from each other can be outputted step by step.

Also, if the degree of the fatigue or careless of the driver is large, since the intrusion for the right side lane or the left side lane of the both sides of the road will be increased, for example, if it intrudes the lane or the generating frequency of the intrusion is large by analyzing the image of the camera 120, the poor driving level such as the fatigue or careless of the driver, etc. can be increased. At this time, the frequency of the intrusion for the lane (that is, a predetermined number of occurrences per unit time) is pre-defined as a plurality of steps and the warning sound or message different from each other can be outputted step by step.

As the above described, according to the apparatus 100 for detecting a poor driving of the present inventive concept, by measuring the distance which the vehicle consistently moves to one direction (left side or right side), that is, the lateral direction, the lane tracking poor pattern for the lateral position change on driving of the vehicle can be determined. In the apparatus 100 for detecting a poor driving of the present inventive concept, by determining the position corresponding to the case which the movement amount of the lateral distance sustained in either direction (left, or right) is maintained (or not become large anymore) without the rising change more than a predetermined flow amount during a predetermined time as the direction change position, and determining the case which the change amount of the lateral position is more than a predetermined size as the lane tracking poor pattern, based on this, the lane departure possibility can be effectively notified or warned to the driver in advance depending on the level of the fatigue or carelessness driving state of the driver.

In other words, by determining the position which the movement amount of the lateral distance is not large anymore during a predetermined time as the direction change position, and based on this, by calculating the movement amount of the lateral distance from the previous direction change position, the change situation of the lateral position of the vehicle can be more quickly and consistently detected and the poor driving situation can be effectively warned, also, in the case of moving to the vicinity of the center, if the poor driving pattern can be determined according to the driving situation such as the case which the time length of the distance movement is large, and by considering the width of the road, the detecting frequency of the surrounding vehicles, etc., the poor driving pattern can be more accurately determined. Above this, considering the generating frequency or size of the lateral position change, the lane intrusion, etc., since it is possible to guide the poor driving situation depending on the level of the fatigue or carelessness of the vehicle's driver, the safe driving of the driver can be assisted and the occurrence of a traffic accident can be remarkably reduced.

In the above description, the present inventive concept has been described through specific elements, embodiments, and drawings, it is only provided to assist in a comprehensive understanding of the present inventive concept, the present inventive concept is not limited to the embodiments, and it will be understood by those skilled in the art that the present inventive concept may be implemented as various modifications and variations without departing from the spirit of the present inventive concept. Accordingly, the scope of the present inventive concept is recited in the appended claims, not the above descriptions, and all differences within the equivalent scope of the present inventive concept will be construed as being included in the present inventive concept.

What is claimed is:

1. A method for detecting a poor driving pattern, the method comprising:
determining a direction change position by tracking a progress of a lateral position change of a the vehicle while moving on a road based on vehicle driving information;
determining a movement amount of a lateral distance between a previous direction change position to a current direction change position based on a difference of a lateral position change amount; and
determining whether the movement amount of the lateral distance is related to poor driving by comparing the movement amount of the lateral distance with a reference value.

2. The method of claim 1, wherein determining the direction change position comprises determining a position at which the lateral position change is maintained in a predetermined range during a predetermined time.

3. The method of claim 1, wherein determining the direction change position comprises detecting corresponding data for which a change of a value is greater than a distance between the lanes based on a minimum value of a sorting array, and eliminating the corresponding data during a predetermined time in a progress of the lateral position change, wherein the sorting array includes absolute values of a lateral position change data in ascending order or descending order.

4. The method of claim 1, further comprising determining whether the movement amount of the lateral distance is related to poor driving, if the movement amount of the lateral distance is more than the reference value, and wherein the poor driving is excluded if the vehicle moves to a vicinity of a center of the road or the movement amount of the lateral distance is generated during a time longer than a setting time.

5. The method of claim 1, wherein the reference value is variably applied depending on a width of the road or a number of surrounding vehicles.

6. The method of claim 1, further comprising determining a poor driving level corresponding to a poor driving situation of a driver and controlling a corresponding warning output.

7. The method of claim 6, wherein the poor driving level is determined by reflecting a size of the movement amount of the lateral distance, an event generating frequency of the direction change, whether a lane is intruded or not, or an occurrence frequency of the lane intrusion.

8. An apparatus for detecting a poor driving, the apparatus comprising:
a direction change recognizer configured to determine a direction change position by tracking a progress of a lateral position change of a vehicle moving in a road from a vehicle driving information;
a lateral change module configured to determine a movement amount of a lateral distance from a previous direction change position to a current direction change position based on a difference of a lateral position change amount; and
a poor driving detector configured to determine whether the movement amount of the lateral distance is related to poor driving by comparing the movement amount of the lateral distance with a reference value.

9. The apparatus of claim 8, wherein the direction change recognizer is configured to determine a position at which the lateral position change is maintained in a predetermined range during a predetermined time as the direction change position.

10. The apparatus of claim 8, wherein the direction change recognizer is configured to eliminate corresponding data during a predetermined time in a progress of the lateral position change for which a change of a value is detected to be greater than the width between the lanes based on a minimum value of a sorting array, wherein the sorting array includes absolute values of a lateral position change data in ascending order or descending order.

11. The apparatus of claim 8, wherein the poor driving detector is configured to determine poor driving if the movement amount of the lateral distance is more than the reference value, and to exclude the poor driving if the vehicle moves to a vicinity of a center of the road or the movement amount of the lateral distance is generated during a time longer than a setting time.

12. The apparatus of claim 8, wherein the poor driving detector is configured to variably apply the reference value depending on a width of the road or a number of surrounding vehicles.

13. The apparatus of claim 8, wherein the apparatus further comprises a fatigue/carelessness driving level module configured to determine a poor driving level corresponding to a poor driving situation of a driver and to control a corresponding warning output.

14. The apparatus of claim 13, wherein the fatigue/carelessness driving level module is configured to determine the poor driving level by reflecting a size of the movement amount of the lateral distance, an event generating frequency of the direction change, whether a lane is intruded or not, or an occurrence frequency of the lane intrusion.
